(19) United States
(12) Patent Application Publication
(10) Pub. No.: US 2002/0135159 A1
(43) Pub. Date: Sep. 26, 2002

(54) Anti-thrust seating assembly for folding wheelchairs

(76) Inventor: Mervyn M. Watkins, Rancho Palos Verdes, CA (US)

Correspondence Address: SPYROS J. LAZARIS, ESQ., OPPENHEIMER WOLFF & DONNELLY LLP, 38th Floor, 2029 Century Park East, Los Angeles, CA, 90067-3024, US

(21) Appl. No.: 09/817,894

(22) Filed: Mar. 26, 2001

(51) Int. Cl. B62B 7/00

(52) U.S. Cl. 280/650

(57) ABSTRACT

A laterally collapsible wheelchair includes a sling seat having a webbed underlay. The sling seat is constructed to allow an occupant of a wheelchair to slightly recess in the wheelchair when seated, thereby preventing involuntary forward movement while seated in the chair. The wheelchair may also include a front raised portion to add an extra level of restraint preventing a wheelchair occupant from involuntary forward thrusting which may dislodge the occupant from the wheelchair.

### BACKGROUND OF THE INVENTION

1. Field of the Invention

The present invention relates to folding wheelchairs. Specifically, the present invention relates to folding wheelchairs having an anti-thrust seating assembly for preventing wheelchair occupants from unwanted forward movement while seated in the wheelchair.

2. General Background and State of the Art

A common problem for users of wheelchairs involves the level of the seating position of the user in the wheelchair. Often, users of wheelchairs cannot control bodily movements, particularly in the pelvic region, and therefore it is desirable to have an assembly for limiting certain movements of occupants of wheelchairs. One particular type of bodily movement is the forward thrusting of the pelvic region. This commonly occurs involuntarily and can result in a person seated in a wheelchair sliding forward from the seated position out of the wheelchair and possibly also resulting in injury.

Additionally, there are many examples of prior art wheelchairs which are foldable in a lateral, side-to-side manner. However, the prior art does not include any reference which discloses a laterally foldable wheelchair having an assembly for preventing pelvic movement of a wheelchair occupant.

It is accordingly one object of the present invention to provide an anti-thrust assembly for the seating portion of a wheelchair. It is yet another object of the present invention to provide a laterally foldable wheelchair having the anti-thrust assembly. It is still another object of the invention to provide an additional, insertable portion to provide an extra degree of restraint for a person seated in this type of wheelchair.

### INVENTION SUMMARY

In accordance with the above objects, the present invention provides an anti-thrust seating assembly for folding wheelchairs. The anti-thrust seating assembly comprises a sling seat having a webbed underlay made from a fabric woven to form a plurality of webbed loops. The sling seat is attached to a seat portion of a frame of a wheelchair. The present invention may also include a fabric pad placed over and attached to the webbed underlay on the sling seat to provide a more comfortable seating arrangement for an occupant of a wheelchair. Each of the plurality of webbed loops has a pair of webbed ends which are releasably attached to the seat portion. In one embodiment, the wheelchair has a pair of side support rods releasably attached to the frame. In this embodiment, the webbed ends formed by the webbed underlay are releasably attached to the pair of side support rods. Also in this embodiment, the sling seat is positioned slightly lower than the seat portion to prevent a wheelchair occupant from sliding out of the sling seat.

Where the webbed ends of the sling seat are attached directly to the seat portion, the sling seat is raisable or lowerable according to the needs of a wheelchair occupant by tightening or loosening the webbed ends of the webbed underlay relative to the seat portion. The sling seat includes a tightening mechanism for accomplishing this purpose. Additionally, a front raised portion may be releasably attachable to the wheelchair frame to add an extra degree of restraint to a person seated in the wheelchair.

The present invention also provides a laterally collapsible wheelchair having the anti-thrust seating assembly described above. The laterally collapsible wheelchair includes a frame that is configured to laterally collapse side-to-side. The frame includes a left frame portion, a right frame portion, a seat portion, and a back portion. The laterally collapsible wheelchair also includes a sling seat as described above, the sling seat having a webbed underlay made from a fabric which is woven to form the plurality of webbed loops comprising the underlay.

The present invention further provides a method of preventing a wheelchair occupant from thrusting forward while seated in a wheelchair. The method comprises providing a sling seat having a webbed underlay as described above, and securing the sling seat to the seat portion of a wheelchair.

### BRIEF DESCRIPTION OF THE DRAWINGS

FIG. 1 is a side view of a laterally collapsible wheelchair;

FIG. 2 is a perspective view of a sling seat having a fabric pad and a webbed underlay, with optional side support rods;

FIG. 3 is a bottom view of a sling seat having a plurality of webbed loops and a tightening mechanism;

FIG. 4 is a cross-sectional view of the sling seat looking forward along line 4-4 in FIG. 1;

FIG. 5A is an additional cross-sectional view of the sling seat looking forward generally along line 4-4 in FIG. 1 but showing a lowered sling seat portion and a front raised portion;

FIG. 5B is an additional cross-sectional view of the sling seat looking forward generally along line 4-4 in FIG. 1 but showing a lowered sling seat portion and a front raised portion and a side support rod on each side of the frame;

FIG. 6 is an additional side view of a seat portion of a wheelchair having a recessed sling seat along line 6-6 in FIG. 5B;

FIG. 7 is a close-up view of a right-side side support rod releasably attached to a frame of a wheelchair as seen from view 7 in FIG. 8: and

FIG. 8 is a side view of a laterally collapsible wheelchair having optional side support rods.

### DETAILED DESCRIPTION OF THE EMBODIMENTS

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

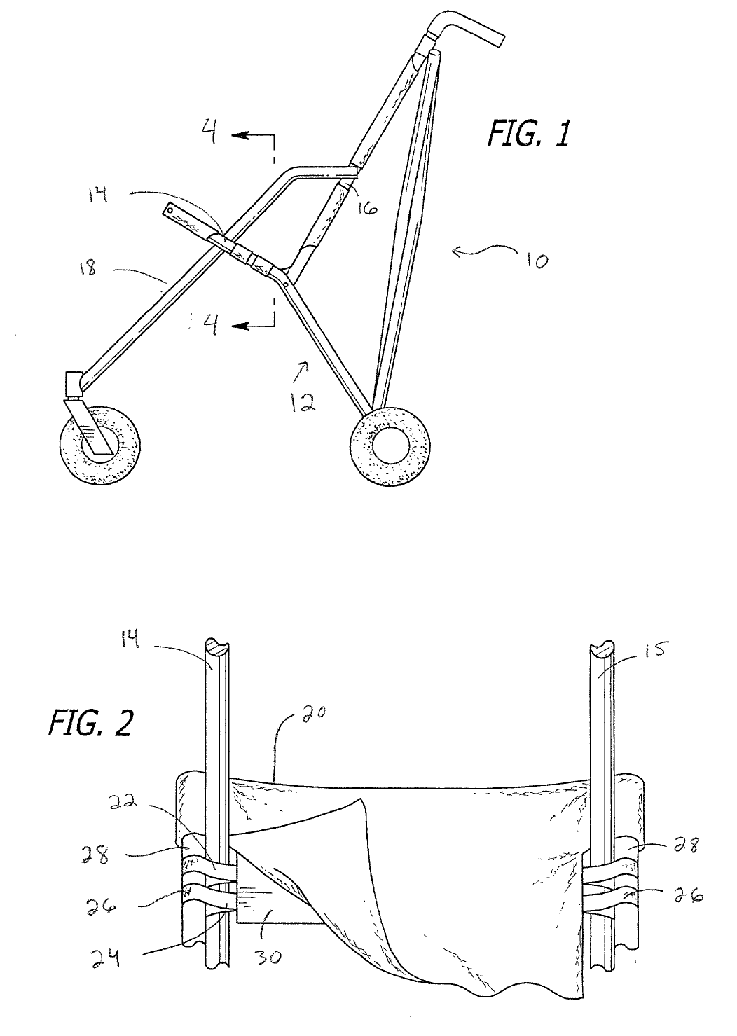

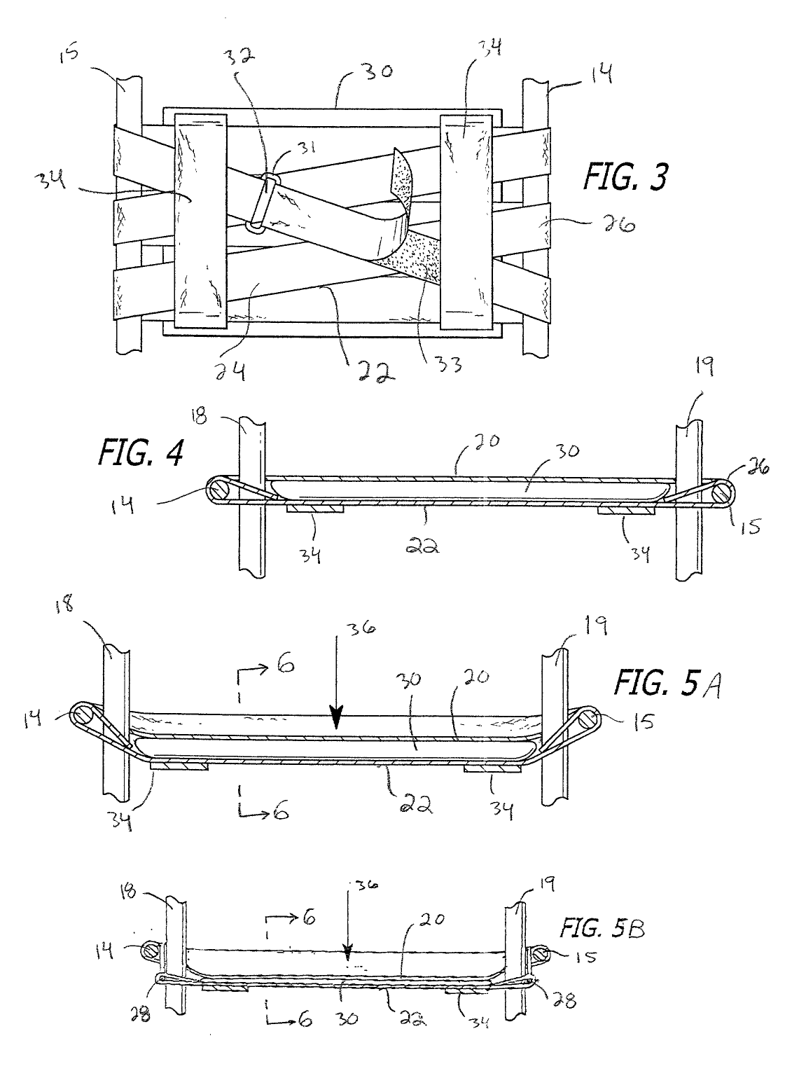

FIG. 1 is a side view of a laterally collapsible wheelchair 10 having a frame 12 which includes a left seat frame portion 14, a right seat frame portion 15 (not shown), a back frame portion 16, a left frame portion 18 and a right frame portion 19 (not shown). The frame 12 of the wheelchair 10 is configured to fold in a side-to-side manner for ease of transportation and storage. The wheelchair 10 also includes a sling seat 20 having a webbed underlay 22 as shown in FIGS. 2 and 3.

FIG. 2 is a perspective view of the sling seat 20 and a portion of the webbed underlay 22. The webbed underlay 22 includes a plurality of webbed loops 24, each of which has a pair of webbed ends 26. Each of the webbed ends 26 is slidably attached to the seat frame portion 14 as shown in FIG. 3. The embodiment of FIG. 2 shows the webbed end 26 slidably attached to a pair of optional side support rods 28. In the embodiment shown in FIG. 2, the front of the sling seat 20 is fixedly positioned to slightly recess below the seat frame portion 14. FIG. 2 also shows a fabric pad 30 coupled under the sling seat 20. The fabric pad 20 holds the webbed underlay 22 together to form a sturdy seat. FIG. 8 is a side view of the wheelchair 10 having an optional side support rod 28 positioned on the frame 12. The side support rod 28 is positioned on the outside of the frame 12 slightly below the seat frame portion 14.

FIG. 3 is a bottom view of the sling seat 20 and the webbed underlay 22. The webbed underlay 22 includes a tightening mechanism 32 which is used to adjust the height level of the sling seat 22. In this embodiment, the tightening mechanism 32 comprises an elongated loop 31 and a hook and loop fastener 33, such as available under the Velcro brand. As noted above, FIG. 2 shows the sling seat 20 attached directly to the seat frame portion 14 of the wheelchair 10. In this embodiment, the tightening mechanism 32 is used to tighten or loosen the webbed underlay 22 to raise or lower the level of the sling seat 20. For example, the sling seat 20 can be raised by tightening the webbed ends 26 of the webbed loops 24 relative to the seat frame portion 14. Also, the sling seat 20 can be lowered by loosening the webbed ends 26 of the webbed loops 24 relative to the seat frameportion 14. In this manner, a person can adjust the height of the sling seat relative to the seat frame portion to provide a desired degree of restraint for a person seated in the wheelchair 10. Therefore, if a greater degree of restraint is needed, the sling seat 20 can be lowered, causing the person seated in the wheelchair to sit lower in the chair and therefore make it more difficult to slide forward out of the sling seat 20. Also shown in FIG. 3 are a plurality of connecting webs 34 for attaching the fabric pad 30 to the webbed underlay 22 of the sling seat 20. The fabric pad 30 and plurality of connecting webs 34 hold the webbed underlay 22 in place. This combination is designed to allow the webbed loops 24 to move relative to the fabric pad 30 and connecting webs 34, so that they may loosened or tightened. FIG. 4 shows a side view of the sling seat 20. FIG. 4 also shows the fabric pad 30 attached to the top of the webbed underlay 22 as well as the connecting webs 34. The fabric pad 30 may be made of other materials that are not fabric, such as polymeric materials or plastics. Many materials are readily available for other components such as the seat 20, the various webs, and other parts.

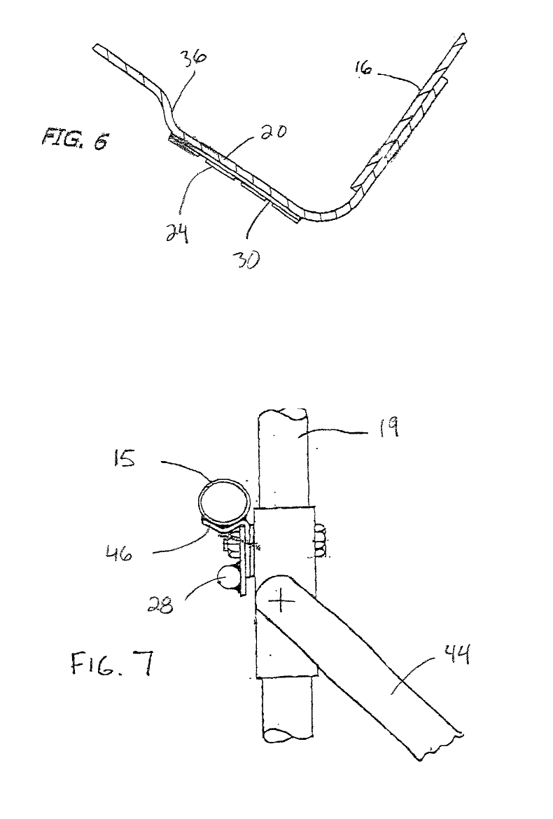

FIG. 5A shows the sling seat 20 in a more lowered position than that shown in FIG. 4. FIG. 5A also shows a front raised portion 36 which is releasably coupled to the frame portions 18 and 19 of the wheelchair 10. Comparing FIG. 4 and FIG. 5A, it is noted that the webbed ends 26 of the webbed loops 24 have been loosened relative to the seat portion 14 such that the sling seat 20 of FIG. 5A hangs lower relative to the seat portion 14 than does the sling seat 20 as shown in FIG. 4. FIG. 5B shows the sling seat 20 releasably coupled to the pair of optional side support rods 28. Comparing FIG. 4 and FIG. 5B, the sling seat 20 of FIG. 5B, it is noted that when coupled to the side support rods 28, the sling seat 20 hangs lower than that shown in FIG. 4.

The pelvis is the foundation on which a person's trunk is balanced. When assuming an upright sifting posture, the pelvis and thighs carry a large amount of the individual body weight, i.e., trunk, head, and upper extremities, which are situated from and above the pelvis. The pelvic structure contains bony prominences which are or can become weight-bearing areas. These bony prominences, known as ischial tuberosities, cannot sustain high and continuous pressure without consequently damaging the surrounding tissue. Therefore, a wheelchair's seat portion should be designed to provide positioning and stability to the sifting base and pressure relief to the bony prominences of the pelvis.

Proper positioning of the femur contributes to pelvic stability. The femurs must be parallel to the seat portion to help balance the pelvis on the ischial tuberosities. When sitting in a level position, the femur slopes downward, resulting in increased hip extension. The femurs are therefore unable to participate in stabilizing the pelvis. Stability is then mainly provided by muscle activity which may be severely compromised in a disabled person.

To alleviate this situation, a pre-ischial bar can be used to keep the femurs parallel to the seat. This pre-ischial bar is the front raised portion 36. The front raised portion 36 takes some of the weight off the ischial area and moves it forward to be supported by the well-padded thighs. This is referred to as weight redistribution or loading of the thighs. With the use of the front raised portion 36, the femurs can assist in stabilizing the pelvis. In turn, the pelvis will rely less on muscle activity for stability and often the occurrence of impaired muscle activity patterns are reduced as the wheelchair occupant feels secure, comfortable, and stable sitting in the wheelchair.

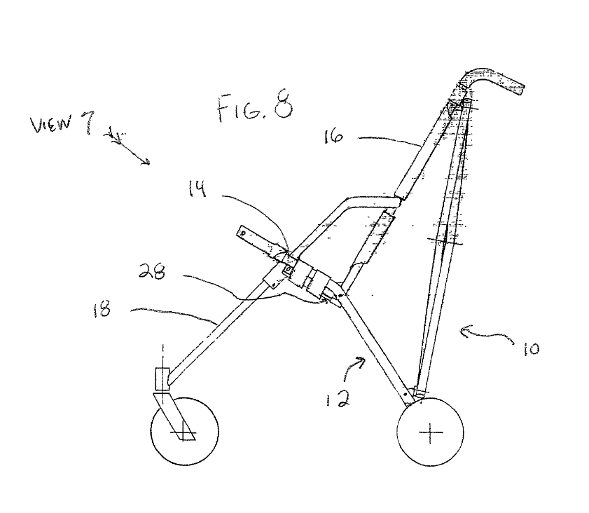

FIG. 6 is a side view of the frame 12 of the wheelchair 10 in which the sling seat is in a lower position relative to the seat frame portion 14. FIG. 6 also shows the front raised portion 36 positioned on a front end of the seat frame portion 14. In the configuration of FIG. 6, a person seated in the wheelchair 10 would rest in a seated position lower than the rest of the frame 12. Also, the front raised portion 36 would provide an added degree of restraint, thereby preventing a person seated in the sling seat 20 from forward pelvic thrusting to dislodge himself or herself from the sling seat 20.

FIG. 7 shows a close-up view of a side support rod 28 releasably attached to the right seat frame portion 15 of the wheelchair 10. As described above, the side support rods 28 are used optionally to attach the sling seat 20 to the seat portion 10 to provide a non-adjustable anti-thrust assembly for the folding wheelchair 10. In this embodiment, the optional side rods 28 can be attached to the frame 15 of the wheelchair 10 to provide a fixed seated position relative to the seat frame portion 15. The bracket assembly 46 which supports side rod 28 is mounted on the right frame portion 19. A compatible bracket assembly is mounted on the left frame portion 18 (not shown). A front cross member 44 is depicted in FIG. 7. It is pivotally mounted to allow movement as the wheelchair is folded or unfolded.

I claim:

1. An anti-thrust assembly for folding wheelchairs, comprising
a sling seat having a plurality of webbed loops, the sling seat being attached to a seat portion of a wheelchair.

2. The assembly of claim 1, further comprising a webbed underlay made from a material woven to form said plurality of webbed loops.

3. The assembly of claim 2, further comprising a pad placed over the webbed underlay to provide a comfortable seating arrangement.

4. The assembly of claim 3, wherein the pad provides support for the webbed underlay and holds said webbed underlay in place.

5. The assembly of claim 1, wherein the plurality of webbed loops each have a pair of webbed ends.

6. The assembly of claim 5, further comprising side support rods releasably attachable to a frame of a wheelchair, the webbed ends being releasably attached to said side support rods.

7. The assembly of claim 6, wherein said sling seat is positioned slightly lower that said seat portion to prevent a wheelchair occupant from sliding out of said sling seat.

8. The assembly of claim 5, wherein said webbed ends are releasably attachable to said seat portion, the sling seat having a tightening mechanism disposed on one of said webbed loops to adjust the tension of the webbed ends relative to said seat portion.

9. The assembly of claim 5, wherein the sling seat is raised by tightening the webbed ends around the seat portion.

10. The assembly of claim 5, wherein the sling seat is lowered by loosening the webbed ends around the seat portion.

11. The assembly of claim 6, wherein the sling seat further comprises a front raised portion releasably attachable to a wheelchair frame.

12. The assembly of claim 11, wherein the front raised portion provides a restraint mechanism for preventing a wheelchair occupant from sliding out of said sling seat.

13. A laterally collapsible wheelchair having an anti-thrust seating assembly, the wheelchair comprising:
a frame configured to collapse side-to-side, said frame having a left frame portion, a right frame portion, and a seat portion; and
a sling seat having a plurality of webbed loops, the sling seat being coupled to said seat portion.

14. The wheelchair of claim 13, further comprising a webbed underlay made from a material woven to form said plurality of webbed loops.

15. The wheelchair of claim 14, further comprising a pad placed over the webbed underlay to provide a comfortable seating arrangement.

16. The wheelchair of claim 15, wherein the pad provides support for the webbed underlay and holds said webbed underlay in place.

17. The wheelchair of claim 13, wherein the plurality of webbed loops each have a pair of webbed ends.

18. The wheelchair of claim 17, further comprising side support rods releasably attachable to a frame of a wheelchair, the webbed ends being releasably attached to said side support rods.

19. The wheelchair of claim 18, wherein said sling seat is positioned slightly lower that said seat portion to prevent a wheelchair occupant from sliding out of said sling seat.

20. The wheelchair of claim 17, wherein said webbed ends are releasably attachable to said seat portion, the sling seat having a tightening mechanism disposed on one of said webbed loops to adjust the tension of the webbed ends relative to said seat portion.

21. The wheelchair of claim 17, wherein the sling seat is raised by tightening the webbed ends around the seat portion.

22. The wheelchair of claim 17, wherein the sling seat is lowered by loosening the webbed ends around the seat portion.

23. The wheelchair of claim 18, wherein the sling seat further comprises a front raised portion releasably attachable to a wheelchair frame.

24. The wheelchair of claim 23, wherein the front raised portion provides a restraint mechanism for preventing a wheelchair occupant from sliding out of said sling seat.

25. A method of preventing a wheelchair occupant from thrusting forward in a wheelchair, comprising:
providing a sling seat having a plurality of webbed loops; and
securing the sling seat to a seat portion of a wheelchair.

26. The method of claim 25, further comprising providing a webbed underlay made from a material woven to form said plurality of webbed loops.

27. The method of claim 26, further comprising providing a pad placed over the webbed underlay to provide a comfortable seating arrangement.

28. The method of claim 25, wherein the plurality of webbed loops each have a pair of webbed ends.

29. The wheelchair of claim 28, further comprising providing side support rods releasably attachable to a frame of the wheelchair, the webbed ends being releasably attached to said side support rods.

30. The method of claim 29, further comprising positioning the sling seat slightly lower that said seat portion to prevent a wheelchair occupant from sliding out of said sling seat.

31. The method of claim 28, further comprising releasably attaching the webbed ends to said seat portion, the sling seat having a tightening mechanism disposed on one of said webbed loops to adjust the tension of the webbed ends relative to said seat portion.

32. The method of claim 28, further comprising raising the sling seat by tightening the webbed ends around said seat portion.

33. The method of claim 28, further comprising lowering the sling seat by loosening the webbed ends around said seat portion.

34. The method of claim 29, further comprising attachably positioning a front raised portion to the seat portion of the wheelchair, the front raised portion being positioned in front of the sling seat to further prevent a wheelchair occupant from forward pelvic thrusting.
